(19) United States
(12) Patent Application Publication
(10) Pub. No.: US 2025/0162288 A1
(43) Pub. Date: May 22, 2025

(54) LAMINATED GLASS

(71) Applicant: SAINT-GOBAIN GLASS FRANCE, COURBEVOIE (FR)

(72) Inventors: Corentin MONMEYRAN, AUBERVILLIERS (FR); VIncent REYMOND, AUBERVILLIERS (FR); Sebastian JANZYK, HERZOGENRATH (DE)

(21) Appl. No.: 18/840,578

(22) PCT Filed: Feb. 17, 2023
(86) PCT No.: PCT/FR2023/050227

§ 371 Date: Aug. 22, 2024

(30) Foreign Application Priority Data
Feb. 25, 2022 (FR) 2201691

(51) Int. Cl. B32B 17/10

(52) U.S. Cl. CPC B32B 17/10064; B32B 17/10137; B32B 17/10229; B32B 17/1077; B32B 2250/05; B32B 2307/202; B32B 2307/302; B32B 2307/7376; B32B 2311/08; B32B 2605/18

(57) ABSTRACT

A laminated glazing includes a first substrate and a second substrate connected to one another via a first polymer interlayer, and optionally a third substrate connected to the second substrate via a second polymer interlayer, the substrates being made of chemically strengthened glass. The glazing includes a solar control coating including at least one functional silver-based metal layer and at least two dielectric coatings, each dielectric coating including at least one dielectric layer, such that each functional metal layer is arranged between two dielectric coatings and a heating coating including a conductive oxide layer located on one face of a substrate that does not include the solar control coating, the solar control coating and the heating coating being located on face 2 or on face 3, each on two different substrates.

The present invention relates to the field of glazings, and more particularly to a laminated glazing for the aeronautical industry, especially cockpit glazings.

Cockpit glazings are complex systems with multiple roles. They provide physical, acoustic and thermal protection from the outside environment.

These glazings are therefore laminated. A laminated glazing comprises two or more glass substrates bonded together by polymer interlayers, also known as laminating interlayers. Aeronautical glazings preferentially comprise at least three substrates.

Conventionally, the faces of a glazing are designated starting from the exterior by numbering the faces of the substrates from the outside toward the inside of the passenger compartment or of the premises which it equips. This means that the incident sunlight passes through the faces in increasing numerical order.

In the case of a laminated glazing, all the faces of the substrates are numbered but the faces of the laminating interlayers are not numbered. Face 1 is outside the building or vehicle, and therefore constitutes the outer wall of the glazing. Faces 2 and 3 are in contact with the laminated interlayer.

In the case of a laminated glazing comprising two substrates, face 4 is inside the building or the vehicle and therefore constitutes the inner wall of the glazing.

In the case of a laminated glazing comprising three substrates, faces 4 and 5 are in contact with the second laminating interlayer and face 6 is inside the building or vehicle and therefore constitutes the inner wall of the glazing.

Laminated glazings for aerospace applications preferentially have a first substrate/first polymer interlayer/second substrate/second polymer interlayer/third substrate structure.

For these applications, the substrates are curved, chemically strengthened glass substrates. The substrates are made from chemically strengthened glass, that is, they comprise a compressed surface zone obtained by ion exchange. This compressed surface zone is obtained by the surface substitution of a glass substrate ion (usually an alkali ion such as sodium or lithium) by an ion with a larger ionic radius (usually an alkali ion, such as potassium or sodium). This creates compressive stresses on the surface of the glass substrate, down to a certain depth. These compressive surface stresses are balanced by the presence of a central tension zone. There is therefore a certain depth at which the transition between compression and tension occurs; this depth is called the surface exchange depth.

These laminated glazings can further comprise coatings conferring additional functionalities. For example, at least one of the substrates can be coated with a heated de-icing coating comprising an electrically conductive layer. These electrically conductive layers can be based on oxides, such as tin-doped indium oxide (ITO).

Because of their intended application, these glazings must have high light transmission and low light absorption. However, while the “substrates”, “interlayers” and “solar control coatings” that make up the glazings allow the visible part of the solar spectrum into the cockpit, they also let most infrared radiation through. This results in excessive heating of the cockpit, and the temperature must be offset by an energy-intensive air-conditioning system.

To alleviate this problem, cockpit glazings can be fitted with a solar control (or protection) element.

The “solar control” function or property refers to a glazing's ability to let in visible light while blocking infrared radiation. The selectivity “S” and the solar factor (SF or g) are used to assess this property. The selectivity corresponds to the ratio of light transmission TLᵥᵢₛ in the visible range of the glazing to the solar factor SF of the glazing (S=TLᵥᵢₛ/SF). Solar factor “SF or g” is understood to mean the ratio in % of the total energy entering the premises through the glazing to the incident solar energy. The solar factor therefore measures the contribution of a glazed unit to the heating of the “room”. The smaller the solar factor, the smaller the solar inputs. The energy transmission corresponds to the percentage of solar energy flow transmitted directly through the glazed wall.

The solar control function therefore corresponds to a sharp reduction in the energy transmission (T_{E}) and solar factor (g) of the glazing, combined with a slight reduction in light transmission (T_{L}).

The addition of a solar control element is designed to prevent excessive overheating. However, the addition of this element must not be at the expense of light transmission and light absorption.

Different types of elements can be used to provide this solar protection function. In particular, it is known to use laminating interlayers with a solar control function. Examples include Saflex® Solar SH and SG interlayers, made from polyvinyl butyral (PVB). These high-light-transmission interlayers absorb infrared (IR) rays. Laminated cockpit glazings comprising such solar control interlayers are not satisfactory. In fact, they are not selective enough.

To overcome these drawbacks, the applicant has developed a laminated glazing with a configuration that is particularly suitable for use as a cockpit glazing comprising a solar control coating. The particular structure of the invention achieves an excellent compromise between low light absorption and light transmission and high selectivity. In particular, the invention makes it possible to achieve a high level of selectivity that is unattainable with other technologies.

The invention therefore relates to a laminated glazing comprising a first substrate (S1) and a second substrate (S2) connected to one another via a first polymer interlayer, and optionally a third substrate (S3) connected to the second substrate (S2) via a second polymer interlayer, the substrates being made of chemically strengthened glass, characterized in that it comprises
a solar control coating comprising at least one functional silver-based metal layer and at least two dielectric coatings, each dielectric coating comprising at least one dielectric layer, such that each functional metal layer is arranged between two dielectric coatings, and
a heating coating comprising a conductive oxide layer located on one face of a substrate that does not comprise the solar control coating, the solar control coating and the heating coating being located on face 2 or on face 3, each on two different substrates.

A special feature of the invention is that the substrates are chemically strengthened. These chemically strengthened glass substrates can be defined as follows:
they comprise a compressed surface zone obtained by ion exchange, and/or
they have a surface exchange depth greater than 50 μm, and/or
they have compressive surface stresses in excess of 100 MPa.

Chemical strengthening methods are well known. Reference may in particular be made to patent application WO1994008910.

The solar control and heating coatings must be applied after the chemical strengthening step. These coatings do not normally undergo a post-deposition heat treatment step. It is therefore preferential for them to have acquired their definitive properties directly after deposition.

According to the invention, the solar control coating comprises at least one functional silver-based metal layer and at least two dielectric coatings, each dielectric coating comprising at least one dielectric layer, such that each functional metal layer is arranged between two dielectric coatings.

According to one embodiment, the solar control coating comprises a single silver-based functional layer. Such coatings offer a good compromise between a significant reduction in solar factor and a minimal reduction in light transmission. High light transmission can only be achieved with single-layer silver coatings. It is not possible to achieve such high light transmissions with multi-layer silver coatings, especially with two-layer silver coatings, as the silver layers necessarily generate an unavoidable minimum absorption. The applicant has discovered that it is very difficult to achieve low enough absorption with silver-based solar control coatings with several functional layers. For example, the absorption on clear glass of a silver-based solar control coating with two functional layers is generally higher than 12%. This is due in particular to the presence of at least four “metal/dielectric” interfaces, each of which necessarily generates absorption. According to one embodiment, the invention is therefore deliberately limited to coatings comprising a single silver-based functional layer, as these are likely to have visible light absorption values of less than 10% when deposited on clear glass. According to this embodiment, the solar control coating does not comprise other layers whose main function is to reflect infrared radiation.

In applications where maximum light transmission is not the key criterion, it is possible to use a solar control coating comprising at least two silver-based functional layers. According to another embodiment, the solar control coating comprises at least two silver-based functional layers. Such coatings enable higher selectivity to be achieved, but require a greater reduction in light transmission.

The particular structure, based on at least three substrates bonded together by two polymer interlayers, is particularly suited to aeronautical applications. In the case of an aircraft, the first substrate is not held by a vehicle connection system. Only the other two substrates, known as structural substrates, are held.

The first substrate constitutes the outer part of the glazing. It is not structurally attached to the vehicle or the building which it equips. It is simply held to the second substrate by the polymer interlayer.

The second and third substrates are mechanically attached in the building or vehicle. These two substrates ensure the protection of the people inside the vehicle. The assembly formed by the second substrate, the second polymer interlayer and the third substrate must therefore offer excellent impact resistance.

As a result, the edge of the first substrate can be set back from that of the second substrate to prevent delamination due to deformation of the glazing under aircraft pressure, or to peripheral tearing and/or shearing of the outer substrate.

The first polymer interlayer is preferably polyurethane-based. The specific choice of this material for this polymer interlayer is justified by the fact that it is less hygroscopic, that is, less likely to absorb and/or retain water, than other polymer interlayers for example made from PVB. This first interlayer keeps the substrate furthest out, and therefore most susceptible to extreme weather conditions.

The second polymer interlayer is preferably based on polyvinylbutadiene. The specific choice of this material for the polymer interlayer is justified by its better mechanical properties, particularly in terms of impact resistance. In addition, due to its “inner” position, its chemical durability is less critical than that of the first polymer interlayer.

The glazing according to the invention may have the following features alone or in combination:
the solar control coating comprises a single silver-based metal functional layer,
the solar control coating comprises a single silver-based metal functional layer,
the solar control coating comprises at least two functional silver-based metal layers,
it has a selectivity above 1.4.,
each dielectric coating of the solar control coating comprises oxide-based layers, and the sum of the thicknesses of all the oxide layers of each dielectric coating represents at least 50% of the total thickness of the dielectric coating considered,
the conductive oxide layer is a layer of indium tin oxide (ITO),
the conductive oxide layer has a thickness of at least 50 nm, at least 100 nm, at least 200 nm,
the conductive oxide layer has at least two zones of different thickness, the ratio between the thickness of these two zones being greater than 2, 3, 4 or 6,
the polymer interlayers are chosen from polyurethane (PU) and polyvinyl butadiene (PVB) sheets,
the first polymer interlayer is chosen from polyurethane (PU) sheets,
the second polymer interlayer is chosen from polyvinyl butadiene (PVB) sheets,
the thickness of the first polymer interlayer is between 3 and 10 mm, preferably 4 and 8 mm,
the thickness of the second polymer interlayer is between 0.5 and 4 mm, between 0.5 and 2 mm,
the thickness of the first substrate is between 2 and 4 mm and the thickness of the second substrate is between 4 and 8 mm or between 5 and 7 mm.

The invention also relates:
a laminated glazing according to the invention mounted on a vehicle or on a building, and
to the method for preparing a laminated glazed unit according to the invention,
to the use of a laminated glazed unit according to the invention as solar-control glazed unit for buildings or vehicles,
to a building or vehicle comprising a glazed unit according to the invention.

The invention relates in particular to:
the use of laminated glazing according to the invention as an aircraft cockpit glazing,
an airplane or helicopter, characterized in that it is equipped with the glazing according to the invention, as side or front cockpit glazing.

The preferred features which appear in the remainder of the description are applicable both to the material according to the invention, to the glazing and, where appropriate, to the method, the use, the building or the vehicle according to the invention.

All the describes light features are obtained according to the principles and methods of the ISO 9050 standard relating to the determination of the light and solar features of the glazed units used in glass for the construction industry.

Conventionally, the refractive indices are measured at a wavelength of 550 nm.

Unless otherwise mentioned, the thicknesses mentioned in the present document, without other information, are real or geometrical physical thicknesses denoted Ep and are expressed in nanometers (and not optical thicknesses). The optical thickness Eo is defined as the physical thickness of the layer under consideration multiplied by its refractive index at the wavelength of 550 nm: Eo=n*Ep. As the refractive index is a dimensionless value, it may be considered that the unit of the optical thickness is that chosen for the physical thickness.

Within the meaning of the present invention, the labels “first”, “second”, “third” and “fourth” for the functional layers or the dielectric coatings are defined starting from the substrate carrying the solar control coating and with reference to the layers or coatings having the same function. For example, the closest functional layer to the substrate is the first functional layer, the following moving away from the substrate is the second functional layer, and so on.

The solar control coating is deposited by magnetic-field-assisted cathode sputtering (magnetron method). According to this advantageous embodiment, all the layers of coatings are deposited by magnetic-field-assisted cathode sputtering.

Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or several) layer(s) inserted between these two layers (or layer and coating).

In the present description, unless otherwise indicated, the expression “based on”, used to characterize a material or a layer with respect to what it contains, means that the mass fraction of the constituent that it comprises is at least 50%, in particular at least 70%, preferably at least 90%.

According to the invention:
light reflection corresponds to the reflection of solar radiation in the visible part of the spectrum,
light transmission corresponds to the transmission of solar radiation in the visible part of the spectrum,
light absorption corresponds to the absorption of solar radiation in the visible part of the spectrum.

Ordinary clear glass from 4 to 6 mm thick has the following light characteristics:
light transmittance between 85 and 91.5%,
light reflection between 7 and 9.5%,
light absorption between 0.3 and 5%.

The silver-based functional metal layers comprise at least 95.0%, preferably at least 96.5% and better still at least 98.0% by weight of silver, relative to the weight of the functional layer. Preferably, a silver-based functional metal layer comprises less than 1.0% by weight of metals other than silver, relative to the weight of the silver-based functional metal layer.

The silver-based functional metal layers have a thickness:
greater than 5 nm, 6, nm, 7 nm, 8 nm or 9 nm, and/or
less than 25 nm, 22 nm, 20 nm, 18 nm, 16 nm, 15 nm, 14 nm or 13 nm.

The solar control coating may comprise one or more blocking layers located in contact below and/or above one or more functional layers.

The blocking layers conventionally have the role of protecting the functional layers from possible damage during the deposition of the upper antireflective coating and during a possible high-temperature heat treatment.

The blocking layers are chosen from:
metal layers based on a metal or a metal alloy, metal nitride layers, and metal oxynitride layers of one or more elements chosen from titanium, zinc, tin, nickel, chromium and niobium,
metal oxide layers of one or more elements chosen from titanium, nickel, chromium and niobium.

The blocking layers may in particular be Ti, TiN, TiOx, Nb, NbN, Ni, NiN, Cr, CrN, NiCr, NiCrN, NiCrOx, SnZnN layers. When these blocking layers are deposited in the metal, nitride or oxynitride form, these layers can undergo a partial or complete oxidation according to their thickness and the nature of the layers which surround them, for example, during the deposition of the following layer or by oxidation in contact with the underlying layer.

Preferably, the blocking layers are titanium layers, that is, these layers have been deposited as titanium metal.

According to advantageous embodiments of the invention, the blocking layer or layers satisfy one or several of the following conditions:
each functional metal layer is in contact with a blocking overlayer, and/or
the blocking layers are titanium layers deposited in metal form, and/or
the thickness of each blocking layer is at least 0.05 nm, or between 0.08 and 2.00 nm, between 0.10 and 1.00 nm or between 0.05 and 0.50 nm.

The sum of the thicknesses of all the blocking layers can be less than 2.0 nm, less than 1.5 nm, less than 1.0 nm or less than 0.5 nm.

“Dielectric layer” within the meaning of the present invention should be understood as meaning that, from the perspective of its nature, the material is “nonmetallic”, that is, is not a metal. In the context of the invention, this term denotes a material exhibiting an n/k ratio over the entire wavelength range of the visible region (from 380 nm to 780 nm) which is equal to or greater than 5.

Preferably, each dielectric coating consists solely of one or more dielectric layers. Preferably, there is thus no absorbing layer in the dielectric coatings, in order not to reduce the light transmission.

Improved properties such as selectivity result from precise control of optical interference effects between the different layers making up the coating. This control is achieved by selecting the type, thickness and sequence of dielectric layers making up the dielectric coatings.

The dielectric layers of the coatings exhibit the following characteristics, alone or in combination:
they are deposited by magnetic-field-assisted cathode sputtering,
they have a thickness of greater than 2 nm, preferably between 4 and 200 nm.

The dielectric layers are conventionally selected from oxide-based, nitride-based or oxynitride-based layers. The layers based on one or more elements substantially comprise oxygen and very little nitrogen. The layers based on oxide in particular comprise at least 90%, as atomic percentage, of oxygen relative to the oxygen and nitrogen in said layer. The layers based on nitride comprise essentially nitrogen and very little oxygen. The layers based on nitride comprise at least 90%, as atomic percentage, of nitrogen relative to the oxygen and nitrogen in said. The layers based on oxynitride comprise a mixture of oxygen and nitrogen. The layers based on silicon oxynitride comprise 10 to 90% (limit values excluded), as atomic percentage, of nitrogen relative to the oxygen and nitrogen in said layer.

The amounts of oxygen and nitrogen in a layer are determined by atomic percentages relative to the total amounts of oxygen and nitrogen in the layer in question.

Dielectric layers are conventionally selected from:
layers comprising silicon, aluminum and/or zirconium, optionally doped with at least one other element,
layers based on zinc tin oxide,
titanium oxide-based layers,
zinc oxide-based layers.

The dielectric layers, in addition to their optical function, may have different other functions. By way of example, mention may be made of stabilizing layers, smoothing layers, and barrier layers.

Dielectric layers having a barrier function (hereinafter barrier layer) is understood to mean a layer made of a material capable of forming a barrier to the diffusion of oxygen and water at high temperatures, originating from the ambient atmosphere or from the transparent substrate, toward the functional layer. Such dielectric layers are selected from:
the layers comprise silicon like the layers chosen from oxides such as SiO₂ and Al₂O₃, nitrides, such as silicon nitrides Si₃N₄ and aluminum nitrides AlN, and oxynitrides such as SiOₓN_{y}, AlOₓN_{y} optionally doped using at least one other element,
layers comprising aluminum,
layers based on zinc tin oxide,
titanium oxide-based layers.

The layers comprising silicon comprise at least 50% by weight of silicon relative to the weight of all the elements forming the layer comprising silicon, other than nitrogen and oxygen.

The layers comprising silicon may be selected from layers based on oxide, based on nitride or based on oxynitride, such as layers based on silicon oxide, layers based on silicon nitride and layers based on silicon oxynitride.

The layers based on silicon oxide comprise at least 90%, as atomic percentage, of oxygen relative to the oxygen and nitrogen in the layer based on silicon oxide. The layers based on silicon nitride comprise at least 90%, as atomic percentage, of nitrogen relative to the oxygen and nitrogen in the layer based on silicon nitride. The layers based on silicon oxynitride comprise 10 to 90% (limit values excluded), as atomic percentage, of nitrogen relative to the oxygen and nitrogen in the layer based on silicon oxide. The layers based on silicon oxide are preferably characterized by a refractive index at 550 nm of less than or equal to 1.55. The layers based on silicon nitride are preferably characterized by a refractive index at 550 nm of greater than or equal to 1.95.

The layers comprising silicon may comprise, or consist of, elements other than silicon, oxygen and nitrogen. These elements may be selected from aluminum, boron, titanium and zirconium. The layers comprising silicon may comprise at least 2%, at least 5%, or at least 8% by weight of aluminum relative to the weight of all the elements forming the layer comprising silicon oxide, other than oxygen and nitrogen.

The layers comprising aluminum may be selected from layers based on oxide, based on nitride or based on oxynitride, such as layers based on aluminum oxide, such as Al₂O₃, layers based on aluminum nitride, such as AlN, and layers based on aluminum oxynitride, AlOxNy.

Preferably, the barrier layers are selected from layers comprising silicon, titanium oxide-based layers and zinc-tin oxide-based layers.

The dielectric layers may be so-called stabilizing layers. Within the meaning of the invention, “stabilizing” means that the nature of the layer is selected so as to stabilize the interface between the functional layer and this layer. This stabilization reinforces the adhesion of the functional layer to the surrounding layers. The stabilizing layers are preferably layers based on zinc oxide optionally doped, for example, with aluminum. The zinc oxide is crystallized. The layer based on zinc oxide comprises, in increasing order of preference, at least 90.0%, at least 92%, at least 95%, at least 98.0% by mass of zinc relative to the mass of elements other than oxygen in the zinc oxide-based layer.

The stabilizing dielectric layer or layers can be directly in contact with a functional layer or separated by a blocking layer.

Preferably, the final dielectric layer of each dielectric coating located below a functional layer is a stabilizing dielectric layer. This is because it is advantageous to have a stabilizing layer, for example based on zinc oxide, below a functional layer as it facilitates the adhesion and the crystallization of the silver-based functional layer and increases its quality and its stability.

It is also advantageous to have a stabilizing layer, for example based on zinc oxide, above a functional layer in order to increase the adhesion thereof and to optimally oppose the diffusion on the side of the stack opposite the substrate.

The stabilizing dielectric layer or layers can thus be above and/or below at least one functional layer or each functional layer, either directly in contact therewith or separated by a blocking layer.

Advantageously, each dielectric layer having a barrier function is separated from a functional layer by at least one dielectric layer having a stabilizing function.

The zinc oxide layers have, in increasing order preferably, a thickness of:
at least 3.0 nm, at least 4.0 nm, at least 5.0 nm, and/or
at most 15 nm, at most 10 nm, at most 8.0 nm.

The sum of the physical thicknesses of all the layers comprising silicon in each dielectric coating is greater than 50%, 60% or 70% of the total thickness of the dielectric coating considered.

According to one embodiment, the sum of the physical thicknesses of all the oxide layers of each dielectric coating is greater than 50%, 60%, 70%, 80%, 90%, 95% or 99% of the total thickness of the dielectric coating considered.

A particularly advantageous embodiment relates to a substrate coated with a coating comprising, starting from the substrate:
a first dielectric coating comprising at least one layer having a barrier function and one dielectric layer having a stabilizing function,
a first functional layer,
optionally a blocking layer,
a second dielectric coating comprising at least one dielectric layer having a stabilizing function and a dielectric layer having a barrier function.

A particularly advantageous embodiment relates to a substrate coated with a coating comprising, starting from the substrate:
a first dielectric coating comprising at least one layer having a barrier function and one dielectric layer having a stabilizing function,
a first functional layer,
optionally a blocking layer,
a second dielectric coating comprising at least one first dielectric layer having a stabilizing function, one layer having a barrier function and one second dielectric layer having a stabilizing function,
a second functional layer,
optionally a blocking layer,
a third dielectric coating comprising at least one dielectric layer having a stabilizing function and one layer having a barrier function.

Suitable heating coatings according to the invention are disclosed in particular in application WO 2020/120879. The heating coating comprises at least one electrically conductive layer which is a transparent conductive oxide layer.

Heating is by Joule effect. The heating coating is powered by energized electrodes. Homogeneous heating of a non-rectangular or square shape is impossible with a layer of homogeneous electrical conductivity.

To homogenize heating on complex surfaces, the electrically conductive layer can have an electrical conductivity gradient. This gradient can be obtained by a thickness gradient. Large variations in layer thickness can be used to limit current density in certain parts of the heating surface.

To homogenize the heating, the electrically conductive layer can also comprise ablation lines, called flow separation lines or more commonly flow lines as disclosed in patent EP1897412-B1, which guide the flow of electric current.

These two strategies can be used in combination.

The conductive oxide layer (electrically conductive layer) has one or more of the following features:
it is located on the inward-facing face of the first substrate or on the outward-facing face of the second substrate, and/or
it comprises a conductive oxide layer based on a doped metal oxide such as tin-doped indium oxide (ITO, “Indium Tin Oxide”), aluminum-doped zinc oxide (AZO, “Aluminum Zinc Oxide”), fluorine-doped tin oxide (SnO2:F), and/or
it has a thickness of 2 to 1600 nm, preferably 25 to 500 nm or 50 to 300 nm, and/or
it has a thickness greater than 50 nm, greater than 100 nm, greater than 150 nm, which means it has this thickness over at least part of the substrate surface, and/or
it has a thickness gradient, that is, a variation in its thickness, which is expressed for example by the existence of at least two zones of different thickness and a thickness ratio between these two zones greater than 2, 3, 4 or 6, and/or
it has flow lines to guide the electric current, preferably with a width of between 5 and 1000 μm.

The thickness ratio between these two zones of different thicknesses is therefore the ratio of the thickness of the thicker layer to the thickness of the thinner layer.

Preferably, the mineral glass substrates that make up the glazing are made from soda-lime, aluminosilicate or borosilicate glass.

Preferably, the laminating interlayers comprise one or more sheets of organic polymers. Organic polymers are selected from polyvinyl butyral (PVB), polyurethanes (PU), polyureas, ethylene vinyl acetate (EVA), polyolefins (including polyethylene (PE), polypropylene (PP) or polyisobutylene (P-IB)), polyvinyl chloride and its derivatives (e.g. polyvinyl dichloride (PVDC)), styrenic polymers (e.g. polystyrene (PS), acrylostyrene butadiene (ABS), styrene acrylonitrile (SAN)), polyacrylics (including polyacrylonitrile (PAN) and poly(methyl methacrylate) (PMMA)), polyesters (including poly(ethylene terephthalate) (PET) and poly(butylene terephthalate) (PBT)), polyoxymethylene (POM), polyamides (PA), fluoropolymers such as polychlorotrifluoroethylene (PCTFE), polycarbonates (PC), aromatic polysulfones including polysulfone (PSU), polyphenylene ethers (PPE), epoxies (EP) alone or in blends and/or copolymers of several of these.

According to preferred features of the laminated glazing of the invention:
the laminated glazing comprises a third glass sheet that is linked to the second glass sheet by a second interlayer, and/or
the first glass substrate has a thickness of between 0.5 and 5 mm, preferably between 2 and 4 mm, and/or
the second glass substrate, and where applicable the third glass substrate, are made of glass with a thickness of between 4 and 10 mm, and/or
said interlayers are made of polyurethane (PU), polyvinyl butyral (PVB), ethylene vinyl acetate (EVA) or equivalent, and/or
the first interlayer is made of polyurethane, and/or
the second interlayer is made of polyvinyl butyral (PVB), and/or
the thickness of the first interlayer is between 2 and 10, preferably 4 and 8 mm, and/or
the thickness of the second interlayer is between 0.5 and 4, preferably at most 2 mm, and/or
it has a selectivity greater than 1.4 or 1.5, and/or
it has a light transmission of at least 65% or of at least 68%.

Another object of the invention consists in the use of a laminated glazing disclosed above as building, ground, air or water vehicle glazing, or glazing for street furniture, in particular as aircraft cockpit glazing.

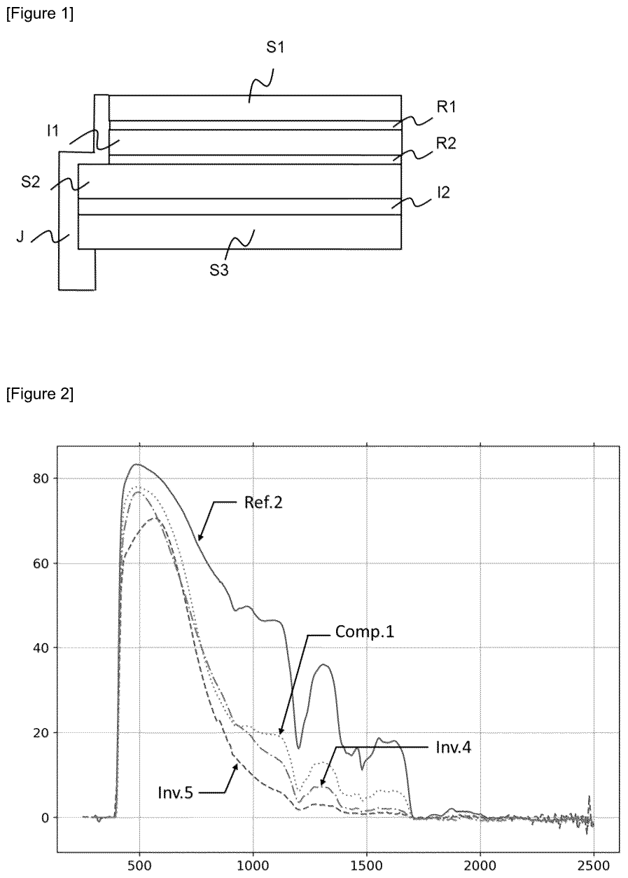

FIG. 1 schematically shows a cross-sectional view of one embodiment of a laminated glazing according to the invention for a cockpit. A laminated glazing according to the invention therefore comprises:
a first glass substrate S1 constituting an outer face of the curved, chemically strengthened glazing, for example 3 mm thick,
a first polyurethane (PU) interlayer I1, for example 5 mm thick,
a second curved, chemically strengthened glass substrate S2, for example 6 mm thick,
a second 1.1 mm thick polyvinyl butyral (PVB) interlayer I2,
a third curved, chemically strengthened glass substrate, for example 6 mm thick,
two coatings R1 and R2, including a heating coating and a solar control coating.

Preferably, the entire peripheral edge of the laminated glazing is covered by a gasket (J). This includes the side edge of the first glass substrate, the side edge of the first interlayer, a portion of the surface of the second glass substrate projecting beyond the first glass substrate, the side edge of the second glass substrate, the side edge of the second interlayer and the side edge of the third glass substrate.

The laminated glazing further comprises:
a heating coating,
a solar control coating comprising at least one silver-based layer,

the heating coating and the solar control coating are each in contact with the first laminating interlayer, on one face of the first substrate and on one face of the second substrate.

### EXAMPLES

### I. Materials and Coatings

### 1. General

In these examples, the glass substrates are chemically strengthened, curved aluminosilicate glass substrates.

The first laminated interlayers are 6.5 mm polyurethane interlayers.

The second interlayers are 1.1 mm thick PVB interlayers.

For the comparative example, a solar control PVB interlayer was used. The Saflex® solar SH41 product has the following characteristics according to ISO 9050:
Solar transmission: 51%, Solar reflection: 5%, Solar absorption: 43%,
Light transmission: 83% and light reflection: 7%.

### 2. Heating Coatings

The ITO14 heating coating consists of a 140 nm indium tin oxide layer. This layer was deposited by magnetron sputtering on a 3 mm glass substrate. It has a layer resistance of 14Ω/□ measured by induction.

The ITO11 heating coating consists of a 180 nm indium tin oxide layer. This layer is deposited by magnetron sputtering on a 3 mm glass substrate. It has a layer resistance of 11Ω/□ measured by induction.

### 3. Solar Control Coatings

The functional metal layers (F) are silver (Ag) layers. The blocking layers are titanium (Ti) metal layers. The dielectric coatings comprise barrier layers and stabilizing layers. The barrier layers are based on titanium oxide and tin-zinc oxide. The stabilizing layers are based on zinc oxide (ZnO).

The conditions for deposition of the layers, which were deposited by sputtering (“magnetron cathode” sputtering), are summarized in table 1.

TABLE 1

| Layer | Target used | Deposition pressure | | Gas |
|---|---|---|---|---|
| ZnO | Zn:Al | 1.8 · 10−3 | mbar | Ar/(Ar + O2) at 63% |
| | (98:2% by wt) | | | |
| SnZnO | Zn:Sn at | 2.10⁻³ | mbar | Ar/(Ar + O₂) at 50% |
| | 64:36% at | | | |
| TiO2 | TiOx | 2.10⁻³ | mbar | Ar/(Ar + O2) at 95% |
| Ti | Ti | 2-3.10⁻³ | mbar | Ar at 100% |
| Ag | Ag | 8.10⁻³ | mbar | Ar at 100% |

Wt: Weight;
at: Atomic

Solar control coatings defined below are deposited on substrates made of clear soda-lime glass with a thickness of 6 mm.

Table 2 lists the materials and the physical thicknesses in nanometers (unless otherwise indicated) for each layer or coating that forms the coatings as a function of their position with respect to the substrate bearing the stack (final line at the bottom of the table).

TABLE 2

| | CS. 1 | CS. 2 | CS3 | CS. 4 | CS. 5 |
|---|---|---|---|---|---|
| SnZnO | — | 24 | 5 | — | 16 |
| Si3N4 | — | — | 20 | | |
| ZnO | — | 5 | 5 | — | 10 |
| BL: Ti | — | 0.1 | 0.1 | — | 0.1 |
| FL: Ag2 | — | 12 | 12 | — | 12 |
| ZnO | — | 5 | 5 | — | 10 |
| SnZnO | — | 53 | — | 10 | 55 |
| Si3N4 | — | — | 55 | | — |
| TiO2 | 28 | — | — | 18.5 | — |
| ZnO | 5 | 5 | 5 | 10 | 10 |
| BL: Ti | 0.1 | 0.1 | 0.1 | 0.1 | 0.1 |
| FL: Ag1 | 17 | 10 | 10 | 16 | 10 |
| ZnO | 5 | 5 | 5 | 10 | 10 |
| TiO2 | 25 | 12 | 12 | 23 | 16 |
| Substrate (mm) | 6 | 6 | 6 | 6 | 6 |

BL: Blocking layer; FL: Functional layer; DC: Dielectric coating.

### II. Configurations: Aeronautical Glazing

The laminated glazings have the following configuration: a first glass substrate S1 which is 3 or 6 mm thick, optionally coated on face 2 with a coating/a first polyurethane (PU) interlayer/a second glass substrate S2 which is 3 or 6 mm thick, optionally coated on face 3 with a coating/a second polyvinyl butyral (PVB) interlayer/a third substrate which is 6 mm thick.

The reference glazings do not comprise a solar control coating.

The glazings according to the invention comprise a solar control coating and a heating coating on face 2 or 3 of the glazing.

Glazing Comp. 1 comprises a PVB solar control as second interlayer.

The table below shows the different configurations tested.

| Glazing | Face 2 | Face 3 | PVB Solar control |
|---|---|---|---|
| Ref. 1 | ITO 14 | — | No |
| Inv. 1 | ITO 14 | CS1 | No |
| Inv. 2 | ITO 14 | CS2 | No |
| Inv. 3 | ITO 14 | CS3 | No |
| Ref. 2 | | ITO 11 | No |
| Comp. 1 | — | ITO 11 | Yes |
| Inv. 4 | CS4 | ITO 11 | No |
| Inv. 5 | ITO11 | CS5 | No |

### 1. First Tests

The performance on glazings Ref. 1, Inv. 1, Inv. 2 and Inv. 3 was obtained by simulation.

| | Réf. 1 | Inv. 1 | Inv. 2 | Inv. 3 |
|---|---|---|---|---|
| T_{L} (%) | 81 | 74 | 70 | 71 |
| T_{E} (%) | 55 | 39 | 32 | 32 |
| g (%) | 64 | 49 | 43 | 44 |
| s | 1.26 | 1.51 | 1.62 | 1.61 |
| Δs (%) | — | 20 | 29 | 28 |

Δs (%) relative to reference

### 2. Second Tests

Glazings Ref. 2, comp. 1, Inv. 4 and Inv. 5 are physical samples.

| | Ref. 2 | Comp. 1 | Inv. 4 | Inv. 5 |
|---|---|---|---|---|
| T_{L} | 81 | 75 | 72 | 69 |
| T_{E} | 56 | 42 | 40 | 36 |
| g | 65 | 56 | 48 | 46 |
| s | 1.25 | 1.34 | 1.50 | 1.50 |

The invention makes it possible to obtain a laminated glazing that is highly satisfactory for aeronautics.

The invention offers a significant improvement in selectivity compared with a glazing with no solar control coating (comparison of the glazings of the invention and Ref). The glazings of the invention have a selectivity of at least 1.40.

When comparing the “first tests” with the “second tests”, a drop in selectivity is observed. This is partly due to the fact that the ITO11 heating coating is less transparent than the ITO14 heating coating. To obtain glazings with high light transmission, less absorbent functional coatings were used.

A glazing with a single layer of silver provides high light transmission and improved selectivity (Inv. 1 and Inv. 4). The use of a two-layer silver coating also provides high selectivity, but at the expense of light transmission (several TL points lower than with a single-layer silver coating).

The addition of a low-absorption solar control coating according to the invention results in a drastic reduction in energy transmission, in particular at least 16 percentage points for a single-layer silver coating (Inv. 4 vs Ref. 2) and at least 20 percentage points for a two-layer silver coating (Inv. 5 vs Ref. 2).

It also drastically reduces the solar factor.

Glazing comp. 1 does not achieve the same advantageous effects as the invention.

The glazings according to the invention offer a good compromise between high light transmission and selectivity and low solar factor.

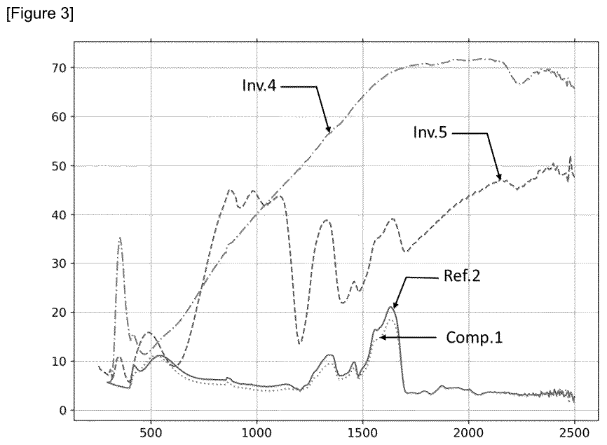

FIGS. 2 and 3 show transmission and reflection as a function of wavelength for examples Ref. 2, Comp. 1, Inv. 4 and Inv. 5, respectively.

It is clear from FIG. 2 that both examples Inv. 4 and Inv. 5 according to the invention and example comp. 1 have similar transmission spectra. Compared with the reference example, they all filter infrared radiation more effectively and allow visible radiation to pass through.

Conversely, FIG. 3 shows that the reflection spectra are very different. This explains the significant differences in solar factor.

The glazings according to the invention offer high light transmission and selectivity.

1. A laminated glazing comprising:
a first substrate and a second substrate connected to one another via a first polymer interlayer, and optionally a third substrate connected to the second substrate via an optional second polymer interlayer, the first and second substrates and the optional third substrate being made of chemically strengthened glass,
a solar control coating comprising at least one functional silver-based metal layer and at least two dielectric coatings, each dielectric coating comprising at least one dielectric layer, such that each functional silver-based metal layer is arranged between two dielectric coatings, and
a heating coating comprising a conductive oxide layer located on one face of a substrate of one of the first and second substrates and the optional third substrate that does not comprise the solar control coating,
the solar control coating and the heating coating being located on face 2 or on face 3 of the laminated glazing, each on two different substrates of the first and second substrates and the optional third substrate.

2. The laminated glazing according to claim 1, wherein the solar control coating comprises a single silver-based metal functional layer.

3. The glazing according to claim 1, wherein the solar control coating comprises at least two functional silver-based metal layers.

4. The laminated glazing according to claim 1, wherein the glazing has a selectivity greater than 1.4.

5. The laminated glazing according to claim 1, wherein each dielectric coating of the solar control coating comprises oxide-based layers, and a sum of the thicknesses of all the oxide layers of each dielectric coating represents at least 50% of a total thickness of the dielectric coating considered.

6. The laminated glazing according to claim 1, wherein the conductive oxide layer is an indium tin oxide (ITO) layer.

7. The glazing according to claim 1, wherein the conductive oxide layer has a thickness of at least 50 nm.

8. The laminated glazing according to claim 1, wherein the conductive oxide layer has at least two zones of different thickness, a ratio between the thickness of the at least two zones being greater than 2, 3, 4 or 6.

9. The laminated glazing according to claim 1, wherein the first and optional second polymer interlayers are selected from polyurethane (PU) and polyvinyl butadiene (PVB) sheets.

10. The laminated glazing according to claim 1, wherein the first polymer interlayer is selected from polyurethane (PU) sheets.

11. The laminated glazing according to claim 1, wherein the optional second polymer interlayer is selected from polyvinyl butadiene (PVB) sheets.

12. The laminated glazing according to claim 1, wherein a thickness of the first polymer interlayer is between 3 and 10 mm and a thickness of the optional second polymer spacer is between 0.5 and 4 mm.

13. The laminated glazing according to claim 1, wherein a thickness of the first substrate is between 2 and 4 mm and a thickness of the second substrate is between 4 and 8 mm or between 5 and 7 mm.

14. A method comprising providing a laminated glazing according to claim 1, as an aircraft cockpit glazing.

15. An aircraft or helicopter, comprising the glazing according to claim 1, as side or front cockpit glazing.
